(19) United States
(12) Patent Application Publication
(10) Pub. No.: US 2012/0251282 A1
(43) Pub. Date: Oct. 4, 2012

(54) DEBRIS KIT FOR HYDRAULIC CYLINDER

(76) Inventors: Ramkumar SELVARAJPANDIAN, Tamil Nadu (IN); Randy R. HAYWARD, Pittsboro, NC (US); Derek P. FURR, West End, NC (US)

(21) Appl. No.: 13/079,543

(22) Filed: Apr. 4, 2011

(51) Int. Cl. F16J 15/52; B23P 6/02; E02F 3/04

(52) U.S. Cl. 414/680; 74/612; 29/401.1

(57) ABSTRACT

A debris kit for a hydraulic cylinder is disclosed. The debris kit may have a base plate assembly with a slot in a length direction that is configured to accommodate sliding of the hydraulic cylinder, and an attachment feature located around at least a portion of a periphery of the slot. The debris kit may also have a flexible boot with a first end connectable to the hydraulic cylinder, and a second end connected to the attachment feature of the base plate assembly.

### TECHNICAL FIELD

The present disclosure is directed to a debris kit and, more particularly, to a debris kit for use with a hydraulic cylinder.

### BACKGROUND

Construction machines, for example compact loaders, wheel loaders, backhoes, and other similar machines commonly include a frame that supports an internal combustion engine, a work tool, an extension arm that pivotally connects the work tool to the frame, and at least one hydraulic cylinder connected between the frame and the extension arm and driven by the engine. In some machine configurations, a first end of each hydraulic cylinder is pivotally connected to the frame at a location near the engine, for example to a frame portion forming a compartment for housing the engine, while a second end is pivotally connected to the extension arm about midway along the length of the extension arm. In these configurations, as the second end of the hydraulic cylinder is driven by pressurized fluid to extend away from the first end, the hydraulic cylinder pushes a tool end of the linkage arm upward and away from a ground surface, thereby moving the work tool through an arc relative to a fixed end of the extension arm. An exemplary machine having such a configuration is disclosed in U.S. Pat. No. 7,881,845 that issued to Nichols on Feb. 1, 2011.

A known problem associated with this type of machine involves debris entering the engine compartment via a clearance around the hydraulic cylinder. In particular, an arcuate space is typically provided near the hydraulic cylinder to accommodate pivoting of the hydraulic cylinder about the first end during extending and retracting movements. Because of the location of the hydraulic cylinder relative to the engine housing, this space can allow for the ingress of debris into the engine housing, in some situations. This ingress of debris may be undesired by the operator of the machine and, if left unchecked for an extended period of time, problematic for engine operation and longevity. In addition, it may be possible for the debris to build up within a normally open space near the hydraulic cylinder, thereby inhibiting motion of the hydraulic cylinder and/or causing damage to the cylinder when the hydraulic cylinder attempts to move but is blocked.

The disclosed debris kit is directed to overcoming one or more of the problems set forth above and/or other problems of the prior art.

### SUMMARY

One aspect of the present disclosure is directed to a debris kit for a hydraulic cylinder. The debris kit may include a base plate assembly with a slot in a length direction that is configured to accommodate sliding of the hydraulic cylinder, and an attachment feature located around at least a portion of a periphery of the slot. The debris kit may also include a flexible boot with a first end connectable to the hydraulic cylinder, and a second end connected to the attachment feature of the base plate assembly.

Another aspect of the present disclosure is directed to a method of retrofitting an existing hydraulic cylinder with a debris kit. The method may include mounting a length-wise slot of a base plate assembly around the hydraulic cylinder. The method may also include connecting a first end of a flexible boot to the hydraulic cylinder, and connecting a second end of the flexible boot to an attachment feature of the base plate assembly.

### BRIEF DESCRIPTION OF THE DRAWINGS

FIG. 1 is a pictorial illustration of an exemplary disclosed machine;

FIG. 2 is a pictorial illustration of an exemplary disclosed debris kit that may be used with the machine of FIG. 1; and

FIGS. 3-10 are enlarged pictorial illustrations of portions of the debris kit of FIG. 2.

### DETAILED DESCRIPTION

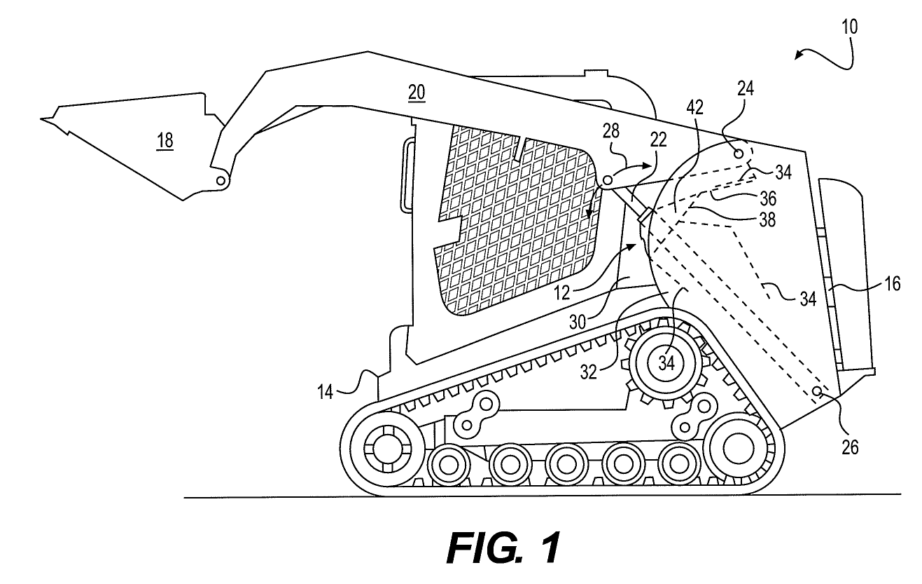

FIG. 1 illustrates a machine 10 having an exemplary disclosed debris kit 12. In accordance with one aspect of this disclosure, machine 10 is illustrated as a compact track loader (e.g., a skid steer loader). It should be noted, however, that debris kit 12 may be used with another type of stationary or mobile machine, if desired. Machine 10 may include a frame 14 supporting and housing a rear-mounted engine 16, a work tool 18 operatively connected to a front end of frame 14 opposite engine 16 by way of an extension arm 20, and a hydraulic cylinder 22 connected to pivot extension arm 20 (and connected work tool 18) about a pivot point 24 of frame 14. Engine 16 may generate a power output directed to move work tool 18 via extensions and retractions of hydraulic cylinder 22. As hydraulic cylinder 22 extends and retracts to move extension arm 20, hydraulic cylinder 22 may pivot about a pivot point 26 in the direction of an arrow 28.

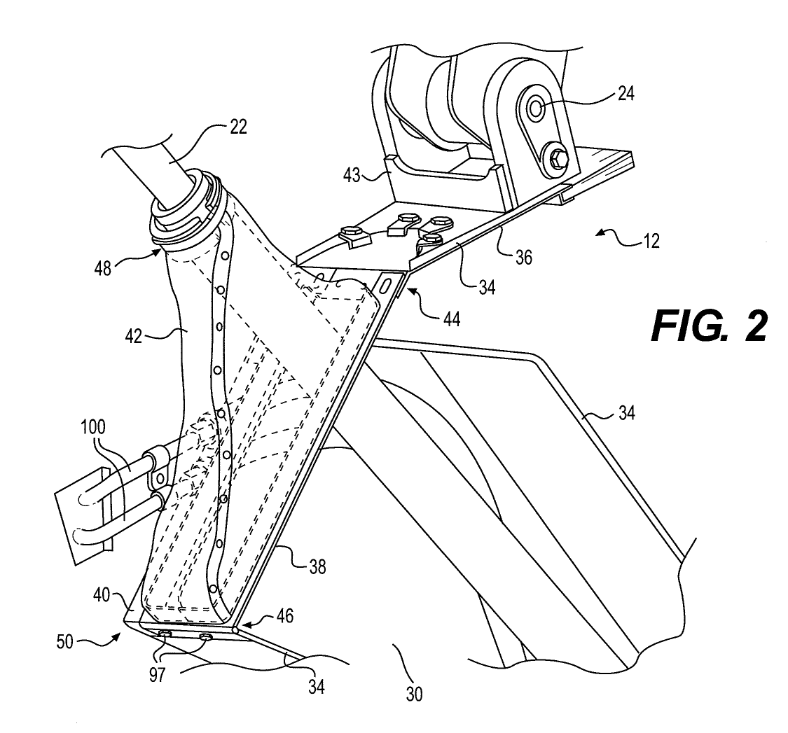

Frame 14 may be an assembly of components that have been welded or otherwise fastened together to form a general support structure for machine 10. In the disclosed embodiment, frame 14 may include an internal frame member 30, an external frame member 32 (removed from FIG. 2 for clarity), and a plurality of cross-frame members 34 that extend between internal and external frame members 30, 32. Internal and external frame members 30, 32 may be generally parallel with a vertical machine plane of symmetry (not shown) that extends in a length and a height direction of machine 10, while cross-frame members 34 may be generally perpendicular to the machine plane of symmetry and both of internal and external frame members 30, 32. Cross-frame members 34 may be oriented generally horizontally (upper most cross-frame member 34 shown in FIG. 2), vertically, and/or obliquely (remaining cross-frame members 34 shown in FIG. 2) relative to a ground surface across which machine 10 traverses, as desired. Cross-frame members 34 may connect external frame member 32 to internal frame member 30.

As shown in FIG. 2, debris kit 12 may include a mounting plate 36, a base plate assembly 38, a block 40, and a flexible boot 42. Mounting plate 36 may be connected to one of cross-frame members 34 (e.g., the cross-frame member 34 located rearward of hydraulic cylinder 22 and associated with a support bracket 43 of pivot point 24). One end 44 of base plate assembly 38 may connect to mounting plate 36, while an opposing end 46 of base plate assembly 38 may mount directly to another of cross-frame members 34 (e.g., the cross-frame member 34 that is shown as located immediately forward of hydraulic cylinder 22 towards work tool 14). Block 40 may be positioned between an inside edge of base plate assembly 38 and internal frame member 30. Flexible boot 42 may be connectable at one end 48 to hydraulic cylinder 22, and connected at an opposing end 50 to base plate assembly 38.

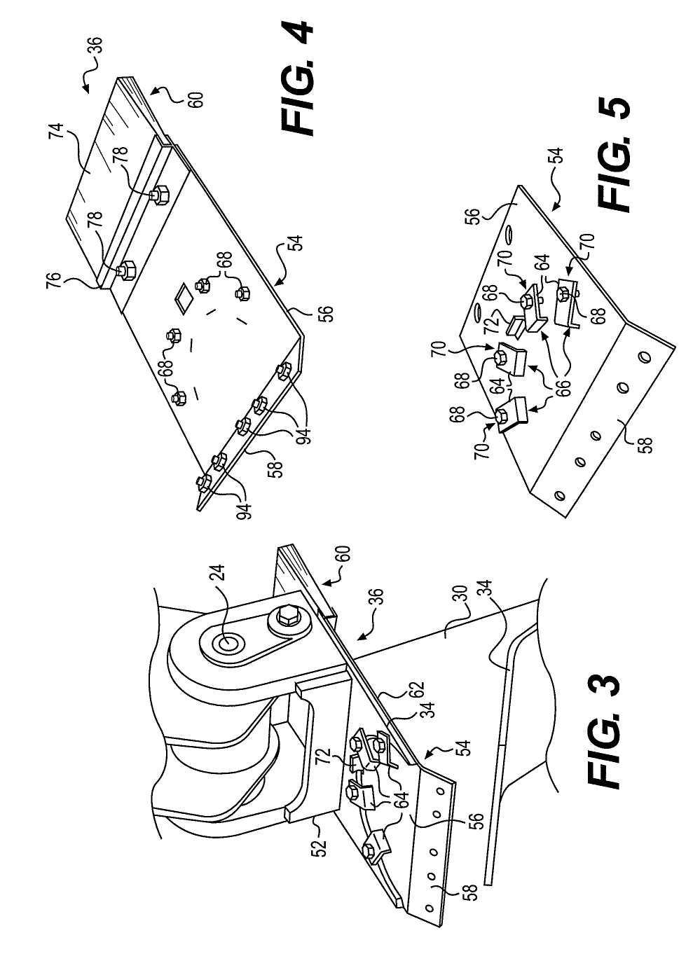

FIGS. 3-5 illustrate mounting plate 36 as being an assembly of multiple components. In particular, mounting plate 36 may include a connection portion 54 having a base surface 56 and an angled surface 58 that is angled away from base surface 56 (i.e., angled downward toward hydraulic cylinder 22 in the disclosed embodiment), and a brush portion 60 that is removably connected to connection portion 54 opposite angled surface 58. Base surface 56 of connection plate 54 may be configured to mate against a bottom surface 62 of cross-frame member 34 during assembly, and be held in place by a plurality of tabs 64. As shown in FIG. 5, tabs 64 may be connected (e.g., welded) at a base end 66 to base surface 56, and be cantilevered a distance away from base end 66. Tabs 64 may be somewhat flexible and, when a fastener 68 associated with each tab 64 is tightened, distal ends 70 of tabs 64 may be drawn towards base surface 56 by fasteners 68. With this configuration, tabs 64 may effectively sandwich cross-frame member 34 against base surface 56 when fasters 68 are tightened, thereby connecting mounting plate 36 to frame 14. In the disclosed embodiment, four tabs 64 are illustrated in a semi-circular arrangement to engage a corresponding semi-circular portion (i.e., a gusset portion) of cross-frame member 34 (referring to FIG. 3). It is contemplated, however, that any number of tabs 64 may be connected to base surface 56 and that tabs 64 may be arranged into any other suitable configuration. When connection portion 54 is mounted to cross-frame member 34, angled surface 58 may be generally perpendicular to a lengthwise axis (not shown) of hydraulic cylinder 22 (referring to FIG. 2). In the disclosed embodiment, a locating tab 72, integral with connection portion 54, may be used to position mounting plate 36 relative to cross-frame member 34 (i.e., connection portion 54 may be pushed toward cross-frame member 34 during assembly until locating tab 72 engages an inner arcuate periphery of cross-frame member 34) before fasteners 68 are tightened, if desired. End 44 of base plate assembly 38 (referring to FIG. 2) may connect to angled surface 58 by way of threaded fasteners (not shown).

As illustrated in FIG. 4, brush portion 60 may be removably fastened to connection portion 54. Specifically, brush portion 60 may include a plurality of bristles 74 that are clamped together by a bracket 76, which may be removably connected via fasteners 78 to an end of connection plate 54 opposite angled surface 58. Brush portion 60 may allow for conduits, for example electrical, hydraulic, and/or pneumatic conduits (not shown) to pass through parted bristles 74 into portions of machine 10 (e.g., into the housing of engine 16), while simultaneously inhibiting debris from entering machine 10 around the conduits.

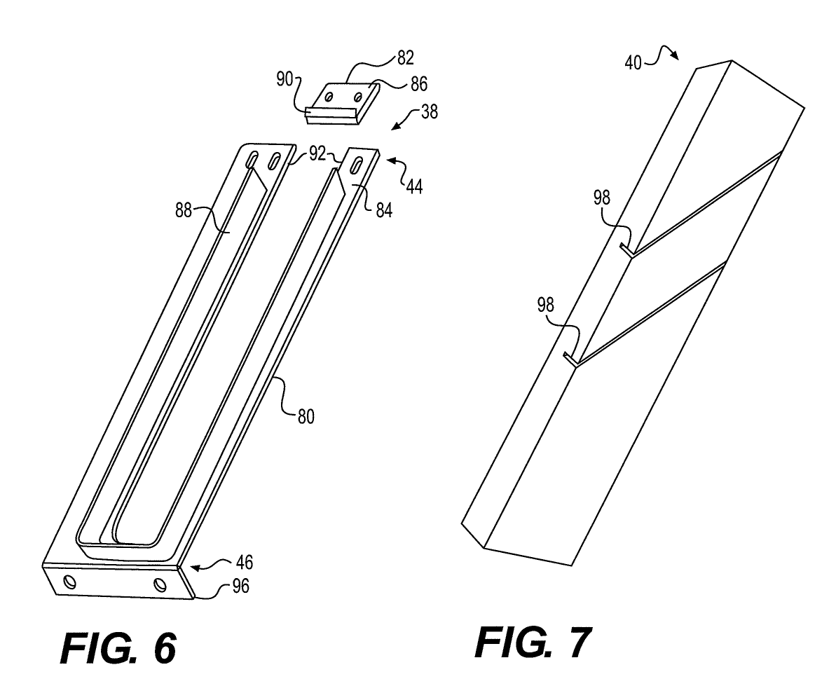

Base plate assembly 38 may be an assembly of components configured to completely surround a portion of hydraulic cylinder 22 (referring to FIG. 2), while providing a mounting base for boot 42 at lower end 50. Specifically, as shown in FIG. 6, base plate assembly 38 may include a u-shaped main component 80 having a generally closed end (i.e., end 46) and a generally open end (i.e., end 44), and a gate component 82 that is configured to substantially close off the generally open end. Each of main component 80 and gate component 82 may include a generally flat base surface 84, 86, respectively, and an integral attachment feature 88, 90 that extends in a direction away from base surfaces 84, 86, respectively. It is contemplated that attachment feature 88 may be formed together with base surfaces 84 and/or 86 or, alternatively, welded to base surfaces 84 and/or 86 after formation thereof, as desired. In the disclosed embodiment, attachment features 88, 90 may together form a substantially continuous lip that is located around a majority portion of a periphery of a slot 92 formed within a general center of base surface 84. The lip may be provided for connection to boot 42, as will be described in more detail below. It is contemplated, that attachment features 88, 90 may be associated with a type of connection interface other than a lip, if desired. Base surfaces 84, 86 may connect base plate assembly 38 at end 44 to angled surface 58 of mounting plate 36 via fasteners 94 (shown only in FIG. 4). A mounting flange 96 may be integral with main component 80 and extend from base surface 84 in a direction opposite attachment feature 88 to directly connect base plate assembly 38 at end 46 to cross-frame member 34 via fasteners 97 (shown only in FIG. 2).

Block 40 may be positioned between an interior edge of base plate assembly 38 (referring to FIG. 2) and internal frame member 30 to inhibit the ingress of debris through a space not blocked by boot 42. Block 40 may be made from a resilient material that is somewhat compressible to fill an undefined and/or variable space, for example from a rubber, malleable plastic, or acrylic foam material. Block 40 may extend generally in a length direction of base plate assembly 38, and, as shown in FIG. 7, have one or more features 98 configured to provide clearance for and/or to receive one or more conduits 100 associated with hydraulic cylinder 22 (referring to FIG. 2). In the disclosed example, features 98 may include grooves that deform and/or compress to provide clearance for conduits 100. In the same or another example, features 98 may include an adhesive, for example double sided tape, which may function to adhere block 40 to conduits 100, thereby retaining block 40 in a desired position adjacent base plate assembly 38. It should be noted that other ways to retain block 40 in place relative to conduits 100 may also be utilized, if desired, for example mechanical fastening, hook-and-loop fastening, ties, etc. The use of block 40 may allow for a simplified design of boot 42, while still inhibiting the ingress of debris around conduits 100. It is contemplated, however, that block 40 may be omitted, if desired, and a shape of boot 42 modified to fill the corresponding space.

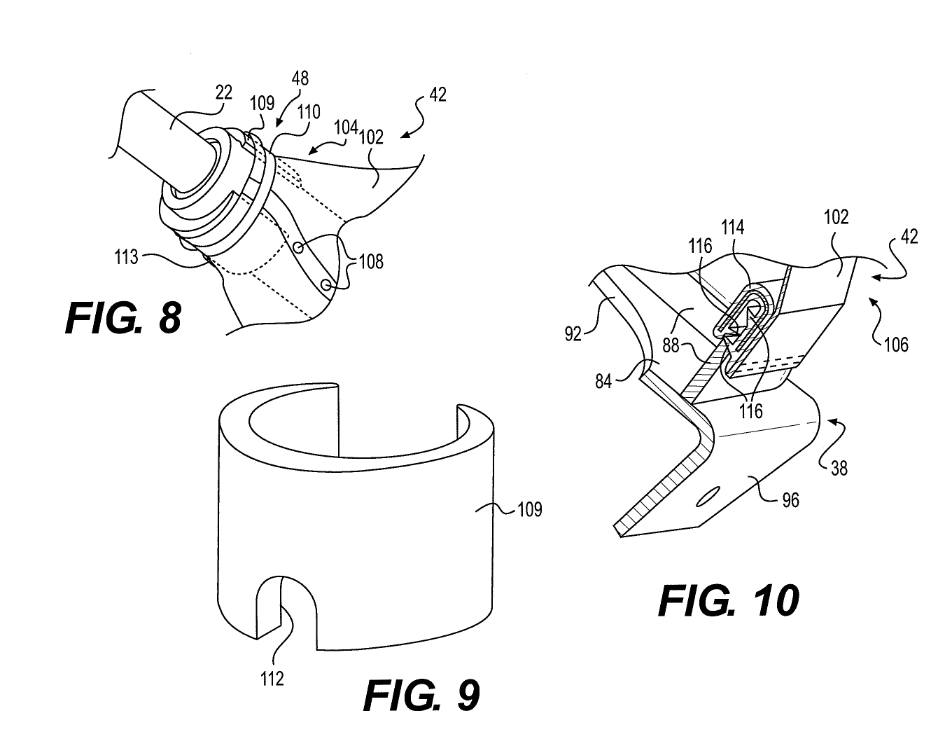

FIGS. 8 and 10 illustrate boot 42 as a multi-component assembly connected to hydraulic cylinder 22 at end 48 and to base plate assembly 38 at end 50. In particular, boot 42 may include a cover portion 102, a first securing portion 104 configured to engage hydraulic cylinder 22 (referring to FIG. 8), and a second securing portion 106 configured to engage base plate assembly 38 (referring to FIG. 10). Cover portion 102 may be generally porous, flexible, and made from, for example, an open weave fabric that allows air to flow through cover portion 102 but inhibits the ingress of debris greater than a particular size. In some embodiments, the open weave fabric may be treated with a material, for example vinyl, that is configured to extend a life of the fabric.

Cover portion 102 may be configured to be retrofitted onto existing hydraulic cylinders 22, without requiring significant service labor and time (e.g., without requiring hydraulic cylinder 22 to be disconnected). In particular, cover portion 102 may be configured to wrap around a portion of hydraulic cylinder 22 while hydraulic cylinder 22 remains connected in place, with ends of cover portion 102 overlapping each other to annularly enclose the portion of hydraulic cylinder 22. One or more fastening devices 108 may be located at the ends of cover portion 102 to retain the ends in the overlapped configuration. In the disclosed embodiment, fastening devices 108 include snaps, although any other type of fastening devices 108, for example zippers, buttons, ties, hook-and-loop fasteners, etc., may be utilized, as desired.

First securing portion 104 may include a grommet 109 and a ring 110. Grommet 109 may be configured to engage a portion of hydraulic cylinder 22, for example a rod-end of a tube portion of hydraulic cylinder 22. As shown in the embodiment of FIG. 9, grommet 109 may be a flexible, single-piece component made from, for example, rubber, and having a generally c-shaped cross-section with an inner diameter just less than an outer diameter of the tube portion of hydraulic cylinder 22. In this configuration, grommet 109 may be deformed (e.g., opened) to fit around hydraulic cylinder 22, and then released to engage hydraulic cylinder 22, grommet 109 thereby being retained in place at the rod-end of the tube portion by elastic deformation. It is contemplated that grommet 109 may have a configuration other than described above, if desired, for example a non-flexible, multi-piece design. As also shown in FIG. 9, grommet 109 may have a cutout 112 configured to provide clearance around a conduit coupling (not shown) of hydraulic cylinder 22. It is contemplated that, in addition to providing clearance for a conduit coupling 113 of hydraulic cylinder 22, the engagement of cutout 112 with conduit coupling 113 may help to retain grommet 109 in place at the rod-end of the tube portion of hydraulic cylinder 22. An axial edge of cover portion 102 may be placed either inside of grommet 109 (i.e., between grommet 109 and hydraulic cylinder 22) or outside of grommet 109, and ring 110 clamped around grommet 109 and/or the axial edge of cover portion 102 to thereby connect cover portion 102 to grommet 109 and hydraulic cylinder 22. Ring 110 may be tightened (i.e., reduced in diameter) to clamp grommet 109 and/or cover portion 102 to hydraulic cylinder 22 by way of deformation (e.g., crimping), mechanical fastening, or in another manner known in the art.

Second securing portion 106, as shown in FIG. 10, may include a seal 114 that is fixedly attached to cover portion 102 and removably connectable to attachment feature 88 of base plate assembly 38. In the disclosed embodiment, seal 114 may be a semi-rigid component fabricated from, for example, a rubber-coated metal clip, and sewn or otherwise fastened or bonded to an axial edge of cover portion 102. Seal 114 may have a generally u-shaped cross-section, with a plurality of rubber knife edges 116 that extend inward from opposing internal surfaces at an angle toward a closed end of the u-shaped cross-section. Knife edges 116 may extend inward toward each other past a cross-sectional center plane (not shown) in an overlapping manner such that knife edges 116 must be deflected further toward the closed end of the u-shaped cross-section during assembly to attachment feature 88. In this configuration, to remove seal 114 from attachment feature 88, knife edges 116 must first be moved through a compressed and parallel state to an unnatural angle pointing toward the open end of the u-shaped cross-section, which may provide seal 114 with a relatively high resistance to being removed. Other configurations of second securing portion 106 are contemplated, for example snaps, mechanical fasteners, hook-and-loop fasteners, ties, etc, which engage corresponding components and/or geometry of attachment feature 88.

### INDUSTRIAL APPLICABILITY

The debris kit of the present disclosure has wide application in a variety of machine types including, for example, loaders. The disclosed debris kit finds particular applicability with compact machines, where a distance between material loading/unloading is closer to where hydraulic cylinders of the machine operate, creating the potential for significant debris contamination of the operating space.

Debris kit 12 may be retrofitted onto existing hydraulic cylinders 22. Specifically, to retrofit debris kit 12 onto an existing hydraulic cylinder 22, a service technician may first raise extension arm 20 to an elevated position (referring to FIG. 1), and move a lift brace (not shown) to engage and hold extension arm 20 in place. The service technician may then secure mounting plate 36 (already having brush portion 60 connected thereto) into position by sandwiching the cross-frame member 34 located just below pivot support bracket 43 between base surface 56 and tabs 64 via fasteners 68 (referring to FIG. 3). The technician may then position slot 92 of base plate assembly 38 around hydraulic cylinder 22, connect end 44 of base plate assembly 38 to angled surface 58 of mounting plate 36 via fasteners 94 (referring to FIG. 2), and connect flange 96 at end 46 to the cross-frame member 34 located forward of hydraulic cylinder 22 via fasteners 97. Cover portion 102 of boot 42 may then be wrapped by the technician around the rod-end tube portion of hydraulic cylinder 22, closed via snaps 108, connected at first end 48 to hydraulic cylinder 22 via grommet 109 and ring 110, and connected at second end 50 to attachment feature 88 of base plate assembly 38 via seal 114. Block 40 may be placed between internal frame member 30 and base plate assembly 38 before or after assembly of boot 42.

During operation, in addition to inhibiting debris from entering the compartment housing engine 16 via the arcuate opening at hydraulic cylinder 22, debris kit 12 may also help to inhibit the debris from entering engine 16 itself. In particular, engine 16 may be fluidly connected to draw inlet air through boot 42 (i.e., through the openings in the fabric of cover portion 102). In this manner, boot 42 may act as a pre-screener to inhibit large debris from being drawn into engine 16 (i.e., into finer air cleaners of engine 16 that may be located downstream of boot 42). This configuration may help prolong the life of different engine components and/or reduce maintenance requirements of machine 10. In addition, by inhibiting the buildup of debris around hydraulic cylinder 22, structural damage to hydraulic cylinder 22 caused by the debris may be avoided.

It will be apparent to those skilled in the art that various modifications and variations can be made to the debris kit of the present disclosure without departing from the scope of the disclosure. Other embodiments will be apparent to those skilled in the art from consideration of the specification and practice of the debris kit disclosed herein. It is intended that the specification and examples be considered as exemplary only, with a true scope of the disclosure being indicated by the following claims and their equivalents.

What is claimed is:

1. A debris kit for a hydraulic cylinder, comprising:
a base plate assembly having a slot in a length direction that is configured to accommodate movement of the hydraulic cylinder, and an attachment feature located around at least a portion of a periphery of the slot; and
a flexible boot having a first end connectable to the hydraulic cylinder, and a second end connected to the attachment feature of the base plate assembly.

2. The debris kit of claim 1, wherein:
the attachment feature includes a lip extending in a direction away from a base surface of the base plate assembly; and
the at least a portion of the periphery is a majority portion.

3. The debris kit of claim 1, wherein the base plate assembly includes a u-shaped main portion having a generally closed first end and a generally open second end, and a gate portion configured to close off the second end of the main portion.

4. The debris kit of claim 1, wherein the flexible boot is porous.

5. The debris kit of claim 4, wherein the flexible boot is made from an open weave fabric that is coated in vinyl.

6. The debris kit of claim 1, wherein the flexible boot includes a semi-rigid seal at the second end that is removably connected to the attachment feature.

7. The debris kit of claim 6, wherein the semi-rigid seal is generally u-shaped and configured to slide over opposing sides of the attachment feature.

8. The debris kit of claim 7, wherein the semi-rigid seal includes a plurality of flexible knife edges connected to opposing internal surfaces, each of the plurality of flexible knife edges extending inward past a center plane of the semi-rigid seal.

9. The debris kit of claim 1, further including:
a grommet connectable to the hydraulic cylinder; and
a ring configured to connect the second end of the flexible boot to the grommet.

10. The debris kit of claim 9, wherein the grommet is flexible, one piece, and includes a c-shaped cross section.

11. The debris kit of claim 10, wherein the grommet includes a cutout configured to receive a conduit connector of the hydraulic cylinder.

12. The debris kit of claim 1, further including a block, positioned to one side of the base plate assembly and aligned in a length direction with the base plate assembly, the block having a feature configured to receive a conduit associated with the hydraulic cylinder.

13. The debris kit of claim 1, further including a mounting plate having a base surface, and an angled surface extending from an edge of the base surface at an angle and being removably connected to the base plate assembly.

14. The debris kit of claim 13, wherein:
the hydraulic cylinder is pivotally connected at one end to a machine frame; and
the mounting plate includes a plurality of tabs cantilevered from the base surface, and a plurality of fasteners, each of the plurality of fasteners configured to push a corresponding one of the plurality of tabs toward the base surface to sandwich a portion of the machine frame.

15. The debris kit of claim 14, wherein the base plate assembly is connected at a first end to the mounting plate and at a second end opposite the first end directly to the machine frame.

16. The debris kit of claim 13, further including a brush removably connected to an end of the mounting plate opposite the base plate assembly.

17. A method of retrofitting an existing hydraulic cylinder with a debris kit, comprising:
mounting a length-wise slot of a base plate assembly around the hydraulic cylinder;
connecting a first end of a flexible boot to the hydraulic cylinder; and
connecting a second end of the flexible boot to an attachment feature of the base plate assembly.

18. The method of claim 17, wherein the hydraulic cylinder is pivotally connected to a machine frame, and the method further includes:
attaching a mounting plate to a portion of the machine frame with tabs;
connecting a first end of the base plate assembly to the mounting plate;
connecting a second end of the base plate assembly opposite the first end to the machine frame; and
placing a block between a side of the base plate assembly and the machine frame.

19. The method of claim 17, wherein:
connecting the first end of the flexible boot to the hydraulic cylinder includes placing a grommet over the hydraulic cylinder, and fastening the first end of the flexible boot to the grommet with a ring; and
connecting the second end of the flexible boot to the attachment feature includes pressing a u-shaped seal of the flexible boot over the attachment feature such that internal knife edges of the u-shaped seal engage opposing sides of the attachment feature.

20. A machine, comprising
an engine;
a frame configured to support the engine;
a work tool;
an extension arm connected between the frame and the work tool;
a hydraulic cylinder connected at a first end to the frame and at a second end to the extension arm;
a base plate assembly located at the first end of the hydraulic cylinder, and having a slot in a length direction that is configured to accommodate movement of the hydraulic cylinder, and an attachment feature located around at least a portion of a periphery of the slot and extending in a direction away from a face of the base plate assembly; and
a flexible porous boot having a first end connectable to the hydraulic cylinder, and a second end connected to the attachment feature of the base plate assembly,
wherein the engine draws air through the flexible porous boot during operation.
